(19) United States
(12) Patent Application Publication
(10) Pub. No.: US 2002/0104802 A1
(43) Pub. Date: Aug. 8, 2002

(54) System and methods for regeneration of mixed bed demineralizers

(75) Inventors: Louis T. LaBrunda, Stanhope, NJ (US); George C. Flynn, Chester, NJ (US)

Correspondence Address: WOLF GREENFIELD & SACKS, PC, FEDERAL RESERVE PLAZA, 600 ATLANTIC AVENUE, BOSTON, MA, 02210-2211, US

(73) Assignee: United States Filter Corporation

(21) Appl. No.: 09/962,810

(22) Filed: Sep. 25, 2001

Related U.S. Application Data
(60) Provisional application No. 60/234,896, filed on Sep. 25, 2000.

(51) Int. Cl. B01D 15/00

(52) U.S. Cl. 210/660; 210/269

(57) ABSTRACT

Systems and methods for regenerating mixed bed demineralizers are disclosed in this invention. Ion exchange resins are separated in a separation vessel and are separately regenerated in a regeneration vessel. No inert resins are required for separation. Fluid purification and resin regeneration may occur simultaneously, without the use of additional storage tanks or vessels.

### RELATED APPLICATIONS

This non-provisional application claims the benefit under Title 35, U.S. C. §119(e) of co-pending U.S. provisional application serial No. 60/234,896, filed Sep. 25, 2000, incorporated herein by reference.

### BACKGROUND

1. Field of the Invention

The present invention relates to regeneration systems for ion exchange resin and, more particularly, to systems and methods for regenerating exhausted anion and cation exchange resin in a mixed bed demineralizer system.

2. Description of the Related Art

Mixed bed demineralizer systems containing anion and cation exchange resin for the purification of water may have many industrial applications, such as for condensate recirculation systems used to drive steam turbines. It is essential that this water be extremely pure, in order to avoid any adverse effects on the surfaces of the equipment.

There are various designs of resin regeneration systems. One design is a two-vessel regeneration system, in which the anion resin and the cation resin are separated and-regenerated in separate vessels. Examples of two-vessel regeneration systems may be found in U.S. Pat. No. 4,388,417 (Down, et al.), U.S. Pat. No. 4,622,141 (Salem, et al.), U.S. Pat. No. 4,663,051 (Flynn, et al.), U.S. Pat. No. 4,191,644 (Lembo, et al.), U.S. Pat. No. 5,196,122 (O'Brien, et al.), and U.S. Pat. No. 5,212,205 (O'Brien, et al.).

Another design uses an inert intermediate resin to reduce mixing of the anion and cation resins at the interface between the two resins. One example of such a system is disclosed in U.S. Pat. No. 2,666,741 (McMullen). Intermediate resin has also been combined with two-vessel regeneration systems, such as may be found in, for example, U.S. Pat. No. 4,298,696 (Emmett), U.S. Pat. No. 4,457,841 (Emmett), U.S. Pat. No. 4,388,417 (Down, et al.), and U.S. Pat. No. 4,442,229 (Emmett).

### SUMMARY OF THE INVENTION

The present invention relates to systems and methods for an improved method for regenerating the exhausted anion and cation exchange resin in a mixed bed demineralizer system.

In one set of embodiments, the present invention provides a system to regenerate ion exchange resin. The system comprises a first vessel, comprising an ion exchange resin, at least one inlet, at least one outlet, and an interface sensor positioned to determine the ion exchange resin height. The system also comprises a second vessel, comprising at least one inlet fluidly connected to at least one outlet of the first vessel, and at least one out let fluidly connected to at least one of the inlet of the first vessel and a water treatment system.

In another set of embodiments, the present invention provides a system to purify a fluid. The system comprises a first vessel, comprising an ion exchange resin, at least one inlet, at least one outlet, and an interface sensor positioned to determine the ion exchange resin height. The system also comprises a second vessel, comprising at least one inlet fluidly connected to at least one outlet of the first vessel, and at least one outlet. The system further comprises a third vessel, comprising at least one inlet fluidly connected to at least one outlet of the second vessel, and an outlet.

In another set of embodiments, the present invention provides a method to regenerate a spent ion exchange resin mixture. The method comprises the steps of providing a first vessel and a second vessel, providing a spent ion exchange resin mixture in the first vessel, separating the spent ion exchange resin mixture in the first vessel into a first spent resin and a second spent resin, transferring the first spent resin to the second vessel, regenerating the first spent resin in the second vessel to produce a first regenerated resin, transferring the first regenerated resin to the first vessel, transferring the second spent resin to the second vessel, and regenerating the second spent resin in the second vessel to produce a second regenerated resin.

In another set of embodiments, the present invention provides a method to regenerate a spent ion exchange resin mixture. The method comprises the steps of providing a first vessel, a second vessel, and a third vessel, providing a spent ion exchange resin mixture in the third vessel, transferring the spent ion exchange resin mixture from the third vessel to the first vessel, separating the spent ion exchange resin mixture in the first vessel into a first spent resin and a second spent resin, transferring the first spent resin to the second vessel, regenerating the first spent resin in the second vessel to produce a first regenerated resin, transferring the first regenerated resin to the first vessel, transferring the second spent resin to the second vessel, and regenerating the second spent resin in the second vessel to produce a second regenerated resin.

Other advantages, novel features, and objects of the invention will become apparent from the following detailed description of the invention when considered in conjunction with the accompanying drawings, which are schematic and which are not intended to be drawn to scale. In the figures, each identical, or substantially similar component that is illustrated in various figures is represented by a single numeral or notation. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

Non-limiting embodiments of the present invention will be described by way of example with reference to the accompanying drawings in which:

FIG. 1 is a diagram of one embodiment of the invention, showing regenerated resin in a regeneration vessel;

FIG. 2 is a diagram of one embodiment of the invention, showing spent resin entering a separation vessel;

FIG. 3 is a diagram of one embodiment of the invention, showing regenerated resin exiting the regeneration vessel;

FIG. 4 is a diagram of one embodiment of the invention, showing separation of the spent resin in the separation vessel into a cation resin and an anion resin;

FIG. 5 is a diagram of one embodiment of the invention, showing anion resin entering the regeneration vessel;

FIG. 6 is a diagram of one embodiment of the invention, showing regeneration of the anion resin within the regeneration vessel;

FIG. 7 is a diagram of one embodiment of the invention, showing regenerated anion resin reentering the separation vessel;

FIG. 8 is a diagram of one embodiment of the invention, showing spent cation resin entering the regeneration vessel;

FIG. 9 is a diagram of one embodiment of the invention, showing regeneration of the cation resin within the regeneration vessel;

FIG. 10 is a diagram of one embodiment of the invention, the regenerated anion resin entering the regeneration vessel; and

FIG. 11 is a diagram of one embodiment of the invention, showing mixing of the regenerated cation and anion resin into a regenerated mixed resin.

### DETAILED DESCRIPTION

Systems and methods for regenerating mixed bed demineralizers are disclosed in this invention. Ion exchange resins are separated in a separation vessel and are separately regenerated in a regeneration vessel. No inert resins are required for separation. Fluid purification and resin regeneration may occur simultaneously, without the use of additional storage tanks or vessels.

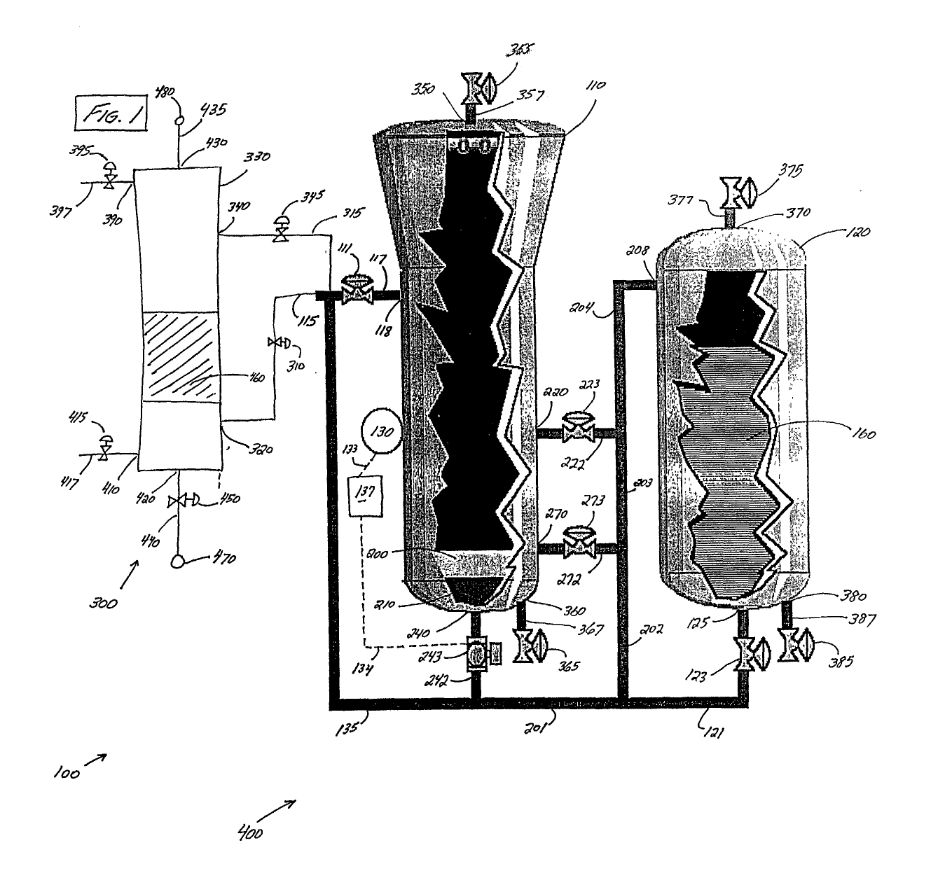

FIG. 1 illustrates a system for regenerating a resin according to one embodiment of the invention. The system 100 comprises a separation vessel 110 and a regeneration vessel 120. Separation vessel 110 may have an interface sensor 130. Separation vessel 110 has an inlet 118 connected to line 117, regulated by valve 111. Inlet 118 may be fluidly connected through line 117 to a fluid purification system 300 through line 115. Flow through line 115 may also be regulated by valve 310. Separation vessel 110 also has outlet 220 connected to line 222, which is regulated by valve 223; outlet 270 connected to line 272, which is regulated by valve 273; and outlet 240 connected to line 242, which is regulated by valve 243. In FIG. 1, outlets 220, 240, and 270 are depicted as being fluidly connected to lines 201, 202, 203, and 204, leading to inlet 208 of regeneration vessel 120. However, in other embodiments of the invention, outlets 220, 270, and 240 of separation vessel 110 may connect with different lines and inlets to regeneration vessel 120, and lines 222, 242, and 272 may not necessarily connect to each other between separation vessel 110 and regeneration vessel 120. Also located on separation vessel 110 are ports 350 and 360, regulated by valves 355 and 365, respectively. Resin-fluidizing fluids may enter or leave through lines 357 and 367, respectively, into separation vessel 110 through ports 355 and 365.

Interface sensor 130 may be connected with a valve to control the transfer of a resin from separation vessel 110. Alternatively, interface sensor 130 may be connected with a pump, a switch, or any other means that may control or regulate the transfer or flow of resin out of separation vessel 110. In the particular embodiment depicted in FIG. 1, interface 130 is connected to a control system 137 by signal line 133. Signal line 133 may be, for example, a pneumatic change, an electronic signal, or a mechanical relay. Control system 137 is connected to valve 243 through signal line 134, controlling or regulating the flow of resin out of separation vessel 110, through outlet 240 and line 242.

Regeneration vessel 120 has outlet 125 connected to line 121, regulated by valve 123. Outlet 125 is fluidly connected to inlet 118 of separation vessel 110 and inlet 320 of service vessel 330 through lines 201 and 135, as depicted is FIG. 1. However, in other embodiments of the invention, separate outlets or individual lines may connect regeneration vessel 120, separation vessel 110, and service vessel 330. Other interconnected piping networks between service vessel 330, separation vessel 110, and regeneration vessel 120 may also be contemplated. Also located on regeneration vessel 120 are ports 370 and 380, regulated by valves 375 and 385, respectively. Resin-fluidizing fluids or regenerant chemical fluids may enter or leave through lines 377 and 387, respectively, into regeneration vessel 120 through ports 370 and 380. In some embodiments of the invention, regeneration vessel 120 may have separate ports for the cation resin regenerant fluid and the anion resin regenerant fluid. In other embodiments, such as the one pictured in FIG. 1, the cation resin regenerant fluid and anion resin regenerant fluid may use a common port 380. Additionally, the resin-fluidizing fluid may use the same port or a different port from the regenerant fluid ports. FIG. 1 shows an embodiment where the fluids use a common port 380.

In some embodiments of the invention, regenerated ion exchange resin mixture 160 may be located within regeneration vessel 120. Regenerated ion exchange resin mixture 160 may comprise, for example, a cation resin and anion resin, or the mixture may comprise several different resin types. The regenerated ion exchange resin may also be referred to as a “service charge.”

In some embodiments of the invention, ion exchange resins 200, 210 may be located within separation vessel 110. These resins may be leftover from previous regeneration cycles, or they may have been added to separation vessel 110 from other locations or other processes. In certain embodiments, resin 200 may be a regenerated anion exchange resin and resin 210 may be unregenerated cation exchange resin. In other embodiments, resin 200 may be a regenerated cation exchange resin and resin 210 may be unregenerated anion exchange resin, or resins 200 and 210 may be mixtures of various resin types.

Fluid purification system 300 includes service vessel 330, fluidly connected through line 115 to the resin regeneration system 400. As shown in FIG. 1, service vessel 330 has inlet 320 connected to line 115, regulated by valve 310; and outlet 340 connected to line 315, regulated by valve 345. However, other piping networks may also be possible. For example, a common port from service vessel 330 may be used as both the inlet and the outlet, or lines 315 and 115 may not be fluidly connected between service vessel 330 and resin regeneration system 400. Fluid purification system 300 also may have fluid inlet 420 and fluid outlet 430. Additional inlets or outlets may also be envisioned. Fluid flow from a point of entry 470 through line 440 entering inlet 420 may be regulated by valve 450. Fluid flow from outlet 430 may be connected through line 435 to a point of use 480. Also located on service vessel 330 are ports 390 and 410, regulated by valves 395 and 415, respectively. Resin-fluidizing fluids may enter or leave through lines 397 and 417, respectively, into service vessel 330 through ports 395 and 415. Additionally, an ion exchange resin mixture 460 may be located within service vessel 330.

Separation vessel 110 may be any vessel suitable for containing and separating ion exchange resin mixtures. Separation vessel 110 may have any shape, for example, rectangular, or spherical. The vessel may also be cylindrical, and it may have an inverted conical section at one end, or it may have a flattened, hemispherical, or conical end. The vessel may be substantially “straight-walled” (i.e., sides perpendicular to the ground), or the vessel may have walls which incline inwards or outwards. Vessels with walls inclining outwards may allow the upward velocity of water or other fluids within the vessel to decrease as the cross-sectional area increases, causing a decline in the upward velocity of the fluid. The decline in the velocity may allow denser resins to settle and separate from lighter resins. For example, the denser resin may be a cation resin, and the lighter resin may be an anion resin. Vessels with suitable inclined walls may thus allow one band of resin to form at the top of the vessel and a second band of resin to form at the bottom. Additional bands of separated resins within the vessel may also be possible. Certain suitably-designed separation vessels may result in relatively sharp transition zones between various resin bands.

With suitably designed separation vessels, a high degree of separation of resins may be achievable, for example, a >99% degree of separation, more preferably, 99.5% separation, and still more preferably, 99.9% separation. A “degree of separation” refers to the amount of cross-contaminant resin that remains in a resin band after separation of a resin mixture into bands or zones of separate resin types has taken place, as calculated on a mass basis or, preferably, a volume basis. A high degree of separation may be desirable in some applications. For example, in the purification of water containing small amounts of ammonia or other amines, cross-contaminating resins that may have been present with the anion resin during the anion resin regeneration treatment may be induced to release additional contaminants into the fluid, which may affect other ion exchange resins. In processes having a high ammonia content, the duration of the service cycle between successive resin regeneration treatments may be extended by using resins having a high degree of separation, enabling continuous service performance in certain cases for at least about three months. As used herein, the “total period of usage” and similar terms refers to the total time of actual operation of the equipment, not including shut-down periods for maintenance, repairs, upgrades, and the like.

Separation vessel 110 may be made out of any material suitable for containing ion exchange resin, such as metal or a plastic. Metals, such as steel or aluminum, may be used to construct the separation vessel in some embodiments, while in other embodiments, polymeric materials, such as polyethylene or a polyolefin, may also be used. The separation vessel may also be lined with a non-reactive material, for example, to protect the surface of the vessel. Such materials may include various glasses, or a polymeric coating, such as polytetrafluoroethylene. Furthermore, the separation vessel may have additional functions, such as enabling mixing operations, or facilitating chemical reactions. Additional components, such as relief valves or additional sensors to, for example, measure conductivity, temperature, pressure, composition, or pH, may also be present on the separation vessel. In certain embodiments, separation vessel 110 may be designed such that it is substantially free of internal components, for example, nozzles, pipes, or sensors.

Interface sensor 130 may be any device that measures or detects the height of an ion exchange resin within separation vessel 110. The position of interface sensor 130 may be fixed within separation vessel 110, or the position may be adjustable as needed. Interface sensor 130 may be positioned on a wall of separation vessel 110, or it may be suspended or positioned inside of separation vessel 110. In one set of embodiments, interface sensor 130 may detect the interface between the top of an ion exchange resin located within separation vessel 110, and water or other fluids above the resin. In other embodiments of the invention, interface sensor 130 may detect an interface region between two different types of resin, or the upper surface of a resin or a fluid (e.g., the interface between the resin or fluid and air). In other embodiments, interface sensor 130 may also detect an interface based on, for example, but not limited to, volume, pressure, pH, turbidity, density, color, or conductivity.

Interface sensor 130 may also be connected to a control system 137. Control system 137 may be a mechanical device, an electronic system, or a computer system or network. Control system 137 may also be a human operator, who causes an operational change upon observing a predetermined signal. Control system 137 may have any number of inputs or outputs to the resin regeneration system, such as to valves 111, 223, 243, 273, 357, 395, or 450, or to additional sensors and instruments along any of the vessels or any of the lines (not pictured). The control lines may be, for example, mechanical relays, electronic signals, or pneumatic changes. Changes which may occur due to control system 137 may include, for example, opening, closing, or partially closing valves; or starting, stopping, or regulating pumps. In one embodiment depicted in FIG. 1, a signal from interface sensor 130 reaches control system 137. Under certain predefined conditions, the signal from interface sensor 130 may causes valve 243 to open or close, for example, to stop the flow of a resin out of separation vessel 110.

Transfer of fluid or resins through any of the lines in the system, for example, lines 115, 117, 121, 135, 201, 202, 203, 204, 222, 242, 272, or 315, may occur by any suitable method. For example, the transfer of resin may occur by applying pressurized air, water, or other suitable fluids, or by using mechanical pumps or other devices. As defined herein, a “resin-fluidizing fluid” or a “fluidizing fluid” includes any fluid which may cause fluidization of an ion exchange resin, for example, but not limited to, air or water. Hydro-pneumatic transfers may be particularly useful. In hydro-pneumatic transfers, pressurized air enters a vessel, fluidizing the resin and forcing it out of the vessel in “plug” form, reducing the amount of resin separation during transfer. A small amount of liquid may also be brought into the vessel during this process to assist with the fluidization of the resin. Alternatively, hydraulic transfers may also be used. In hydraulic transfers, a resin-fluidizing fluid such as pressurized water may enter the vessel, forcing resin out of the vessel in “plug” form, reducing resin separation during the transfer. To illustrate how a resin-fluidizing fluid may be used to transfer a resin by way of example only, in FIG. 1, to remove a fluid from separation vessel 110, valve 355 may be opened to allow a resin-fluidizing fluid, for example, pressurized water, to enter separation vessel 110 from line 357 through inlet 350. Valve 243 may also be opened, for example, allowing resin and fluid to leave separation vessel through line 242. Other valves may be opened or closed as desired to direct the flow of resin to another vessel or operation, for example, to regeneration vessel 120.

Regeneration vessel 120 may be any vessel suitable for performing regeneration of the ion exchange resins. Regeneration vessel 120 may have any shape, for example, rectangular, spherical, or cylindrical. The vessel may be straight-walled, or it may have walls which incline inwards and outwards. The vessel may have flattened, hemispherical, or conical ends. In some embodiments, regeneration vessel 120 may be made out of a polymeric material, such as polyethylene or a polyolefin. However, in other embodiments, regeneration vessel 120 may be made out of a metal, such as steel or aluminum. In some embodiments, regeneration vessel 120 may also be lined with an inner material. The inner material may be any material that may withstand exposure to the regenerant chemicals used during resin regeneration. The inner material may be, for example, a glass or a polymer such as polytetrafluoroethylene.

The ion exchange resin may be, for example, a cation, an anion, or an inert resin, and it may be present as spherical beads or other discrete particles. Resins that exchange a positive ion, such as hydrogen, for another positive ion, such as copper, iron, or sodium, is a cation resin, while resins that exchange a negative ion, such as hydroxide, for another negative ion, such as chloride, sulfate, or chromate, is an anion resin. Both types of resins may be used to remove various contaminating salts from solution, for example, sodium chloride, potassium chloride, sodium sulfate, silica, or calcium chloride. The ion exchange resin may comprise any material suitable for binding ions or other species from solutions, for example, silica, a zeolite, or a polymer, such as a poly(divinylbenzene-co-styrene). The ion exchange resin materials may include cation resin materials with weak base functional groups on their surface regions, such as, for example, tertiary alkyl amino groups. The ion exchange resin materials may also include anion resin materials, for example, containing type I functional groups, such as quaternary ammonium groups, or type II functional groups, such as dimethyl ethanolamine. The ion exchange resin may be used until it becomes relatively saturated (“spent”), then the resin may be regenerated and reused. For example, cation resins may be regenerated using strong acids, such as sulfuric acid, hydrochloric acid, or mixtures thereof, and anion resins may be regenerated using strong bases, such as ammonium hydroxide, lithium hydroxide, sodium hydroxide, potassium hydroxide, or mixtures thereof. The ion exchange resin may be used within fluid purification system 300 until they are no longer able to maintain a low contaminant ion concentration in a fluid, for example, an ion concentration of 0.55 to 0.66 μS of ions, or an ion concentration below 10 parts per billion (ppb). The ion that is monitored may be any contaminant ion in solution, for example, sodium, chloride, potassium, silica, or sulfate. In other embodiments, the resin may be used until the resin is no longer able to maintain a fluid resistivity above approximately 14 megohm-cm, or more preferably, above approximately 18 megohm-cm. The ion concentration or the resistivity may be measured on a regular basis, for example, daily, hourly, or preferably, continuously. Alternatively, the ion exchange resin may be used for a predetermined time period, for example, for about 3 to 5 days, preferably for about 10 to 14 days, or more preferably for about 30 days, or still more preferably, for more than about 100 days, using suitable regeneration procedures.

Fluid purification system 300 may be any system where purification of a fluid is desired. Fluid purification system 300 may purify the fluid using any suitable technique, for example, ion exchange. The system may contain ion exchange resin 460, used during the fluid purification process. The fluid may be an organic compound, an aqueous solution, or water. The fluid may also contain chemical additives to, for example, stabilize system chemistry, or reduce corrosion. In some applications, ammonia may be a suitable chemical additive; more complex amine compounds and derivatives may be suitable for other applications. Ammonia may be added, for example, to control the pH of the fluid or control the cycle chemistry. Ammonia ions in solution may be removed from the condensate fluid, for example, by ion exchange with a cation resin.

In systems where the fluid to be purified is water, the water may be fresh water, salt water, or waste water, for example, from a water treatment plant, or a manufacturing facility. The water may also be water from a reservoir or a holding tank. In some embodiments, the fluid may be ultra-high purity water. In one set of embodiments, the water may be used in a condensate polishing system, such as in a power plant. Certain non-contaminant ions, such as ammonia, may also be present within the fluid. As depicted in FIG. 1, service vessel 330 is shown as a single tank. However, in other embodiments of the invention, service vessel 330 may be a series of vessels and may include other operations, for example, ultrafiltration or reverse osmosis. Service vessel 330 may contain one or more ion exchange resin materials. Service vessel 330 may further have any number of inlets and any number of outlets.

Point of entry 470 may be any unit operation producing or operating on a fluid, such as, but not limited to, ultrafiltration, sedimentation, distillation, humidification, reverse osmosis, or dialysis. The point of entry may also be a reactor, where a fluid is generated, or a heat exchanging system, where a fluid is used for heating or cooling operations. Alternatively, the point of entry may be a reservoir of liquid, such as a storage vessel, a tank, or an outdoor holding pond, or, in the case of water, the point of entry may also be a natural or artificial body of water, such as a lake or a river. Between the point of entry and resin regeneration system 100 may be any number of additional operations, for example, a reverse osmosis device or a reservoir.

Point of use 480 may be any location in which a liquid is desired. For example, the point of use may be a spigot, a reservoir, or a unit operation in which a liquid is needed, such as may be found in a cooling system, a refrigeration system, or a manufacturing plant. Alternatively, the liquid may be used in equipment that purifies or stores the liquid, for example, in bottles or a tank. The point of use may also be in a chemical plant, a city, or a building such as a house or an apartment complex, or it may be a discharge to the natural environment. Between resin regeneration system 100 and the point of use may be any number of additional operations or distribution networks, for example, an ultrafiltration device, a reservoir, or a water distribution system.

It will be understood that a variety of configurations of the invention may exist. Accordingly, the system illustrated in FIG. 1 may be modified as desired for a particular process. For example, the invention may further include additional piping, valves, sensors, or control systems, without departing from the scope of the invention. In some cases, systems of the invention may include additional components than those illustrated; and in some cases, systems of the invention may not include all of the illustrated components.

The description of this invention contained herein explains the basic operational procedure according to one embodiment of the invention. Only those steps that are required to explain the principles of the invention to those of ordinary skill are described herein. Various method steps may be added or removed as desired without departing from the spirit of the invention.

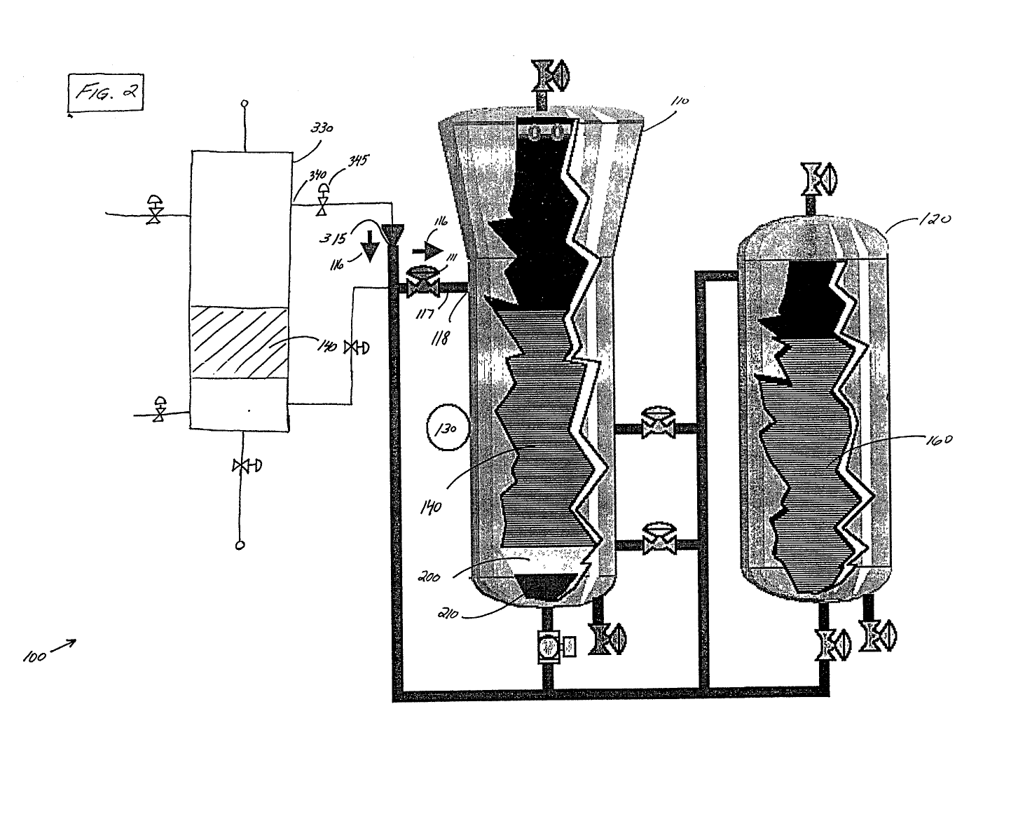

As illustrated in FIG. 2, when a service charge is exhausted, the exhausted or “spent” resin 140 may be “sluiced” (transferred) from service vessel 330 through outlet 340, through lines 315 and 117, into inlet 118 of separation vessel 110. Valves 345 and 111 are opened to allow transfer of the resin, and are closed after transfer of the resin has been completed. The direction of resin movement is indicated by arrows 116. Once the majority of resin 140 has been evacuated from service vessel 330 into separation vessel 110, water or other fluids may be used to rinse the side walls of service vessel 330, as well as internal lines 315 and 117 leading to separation vessel 110, of any remaining or residual resin. Complete flushing of resin transfer lines 315 and 117 may be performed from both ends of the transfer piping, ensuring that all of exhausted resin 140 is removed from the service vessel 330 and placed in separation vessel 110.

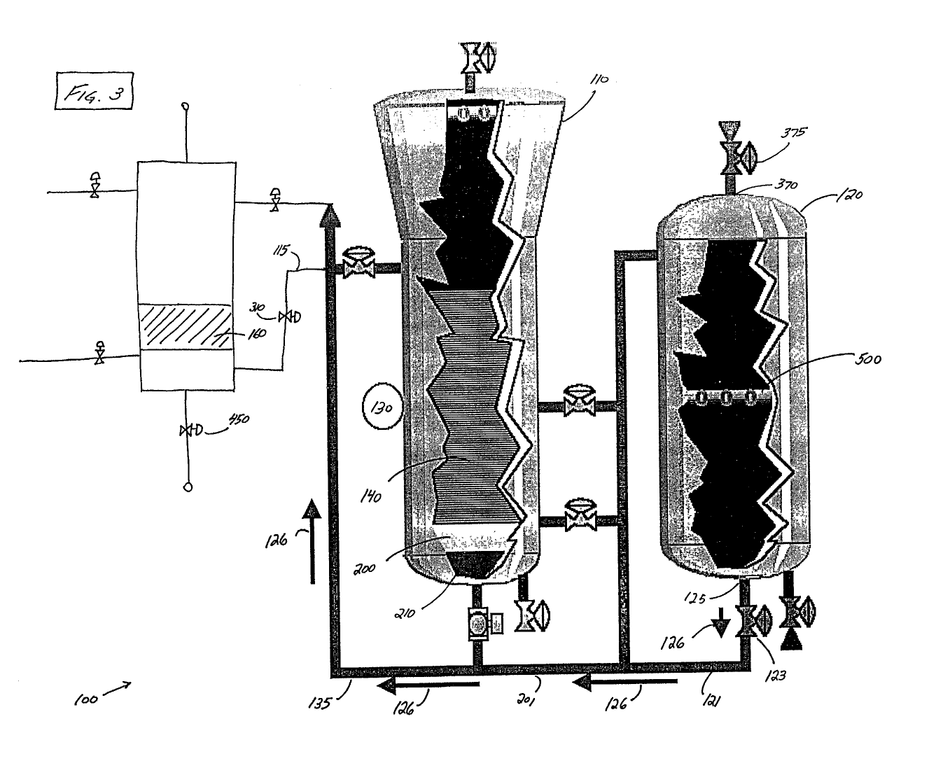

After transfer of exhausted resin 140 from service vessel 330 into separation vessel 110 has been completed, service charge 160 may then be transferred using any suitable technique back to service vessel 330 from regeneration vessel 120 through lines 121, 201, 135, and 115. The flow of resin is indicated in FIG. 3 by arrows 126, and may be initiated by opening valves 123 and 310. Once the majority of resin 160 has been evacuated from regeneration vessel 120, water or other fluids may additionally be brought into regeneration vessel 120 through port 370 by opening valve 375, to rinse any walls and internal components of regeneration vessel 120 of any remaining resin. Bidirectional hydraulic flushing of the transfer piping may also be performed to ensure that regenerated resin 160 has been transferred to service vessel 330. Service vessel 330 may then re-enter service. Valves 123, 310 and 375 are closed and valve 450 is opened. At this point, regeneration vessel 120 may be nearly empty and separation vessel 110 may contain exhausted resin 140 plus residual resins 200 and 210.

In FIG. 3, regeneration tank 120 is depicted as having an internal distributor 500. Internal distributor 500 may be used to distribute one or more fluids within regeneration tank 120. For example, internal distributor 500 may be used to distribute air, water, a regenerant fluid, or a resin-fluidizing fluid. Internal distributor 500 may be connected to one or more of the inlets of regeneration tank 120. For example, it may be connected to port 370 or port 380. In some embodiments of the invention, internal distributor 500 may be fluidly connected to a cation resin regenerant source, an anion resin regenerant source, and a source of a resin-fluidizing fluid.

An optional air scrubbing of the resins may be performed in separation vessel 120 to remove the buildup of crud, fines, or other miscellaneous particles from the resin beads, or to reduce the static attraction among the resin beads, which may aid in declumping or separation. This may be performed by opening valves 355 and 365 and passing pressurized air through ports 350 and 360 of separation vessel 110. Air scrubbing may also enable residual resins 200 and 210 to homogenize with exhausted resin 140.

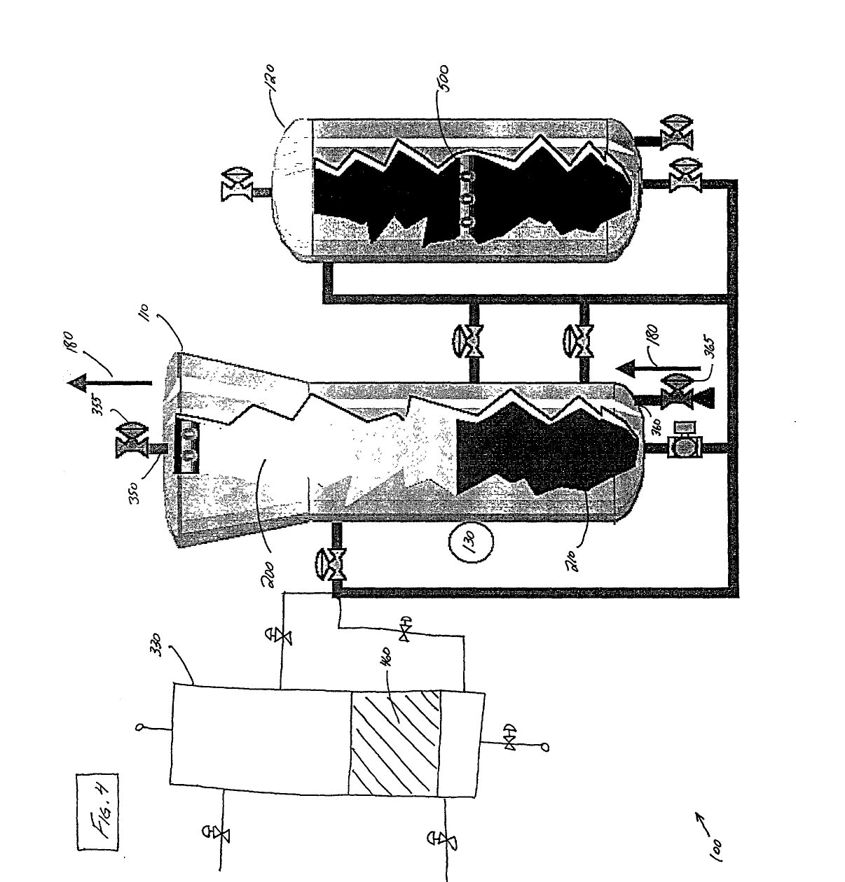

The resins may then be separated into two or more resin types, for example, a cation and an anion resin, or a cation, an anion, and an inert resin. This may be accomplished using any suitable means. For example, the resins may be separated using centrifugal force or allowing the resins to settle passively. Alternatively, fluids may be used to separate the resin particles on the basis of density or size. In one embodiment, an initial flow of water or another fluid may be introduced to the bottom of separation vessel 10 through port 360, as indicated by arrows 180 in FIG. 4. The flow of fluid through separation vessel 110 may be laminar or turbulent. In some embodiments of the invention, separation vessel 110 may be substantially free of internal obstacles, which may promote laminar flow, reducing mixing and separation times. The fluid may cause the resin to lift and expand into the upper reaches of the vessel. The upward fluid flow may be reduced after a predetermined amount of time, for example, linearly or gradually in a controlled stepwise manner over a predefined period. This gradual decrease of the upward force of fluid may allow the natural terminal settling velocities of the different resins to cause the resins to separate. For example, if the anion resin is lighter than the cation resin, the denser cation resins may first settle out, and the less dense anion resin may remain in the upper portion of separation vessel 110. As the controlled upward flow is reduced, the resin may separates into zones of resin. These may or may not be clearly defined zones of resins. In FIG. 4, the resins have been separated into an upper zone of resin 200 and a lower zone of resin 210. Additional resin zones may also be possible, depending on the numbers and types of resins used. The upper zone may be, for example, an anion resin, while the lower zone may be a cation resin, or there may be three zones, consisting of an anion resin, a cation resin, and an inert resin.

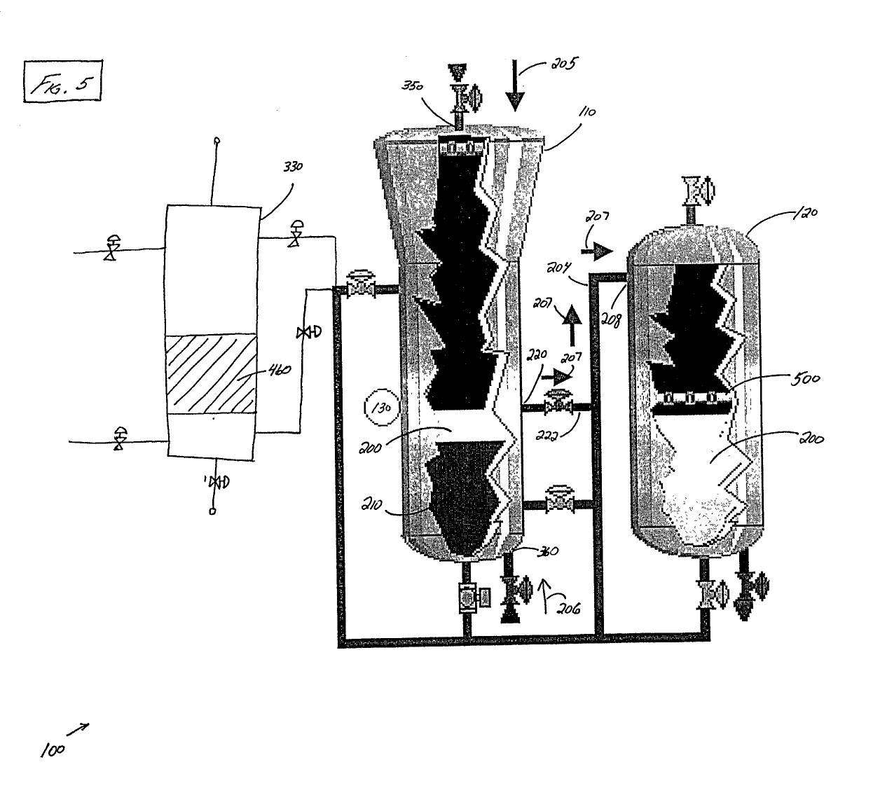

The transfer of the resin 200 out of separation vessel 110 to regeneration vessel 120 may be performed any suitable means, such as hydraulically. For example, in one embodiment shown in FIG. 5, water or another fluid may enter the top of separation vessel 110 through port 350, as indicated by arrow 205, while a low leveling flow may enter the bottom of the vessel through port 360, as indicated by arrow 206. Upper resin 200 may exit separation vessel 110 through side outlet 220, located near the bottom of the upper zone of resin, as indicated by arrows 207. Upper resin 200 then may pass through lines 222 and 204 before entering regeneration vessel 120 through inlet 208. Due to the force of fluid entering separation vessel 110 through port 350, resin below outlet 220 may not be able to leave separation vessel 110; thus, only the upper resin 200 may exit separation vessel 110. Part of upper resin 200 and all of lower resin 210 may still remain within separation vessel 110 after the transfer. In certain embodiments of the invention, the transfer of resin out of separation vessel 110 may also include, besides upper resin 200, a portion of lower resin 210. The amount of resin transferred may be an amount with a predetermined mass or volume. The amount of resin transferred may also be the amount of resin that can be transferred from separation vessel 110 to regeneration vessel 120 during a predetermined amount of time.

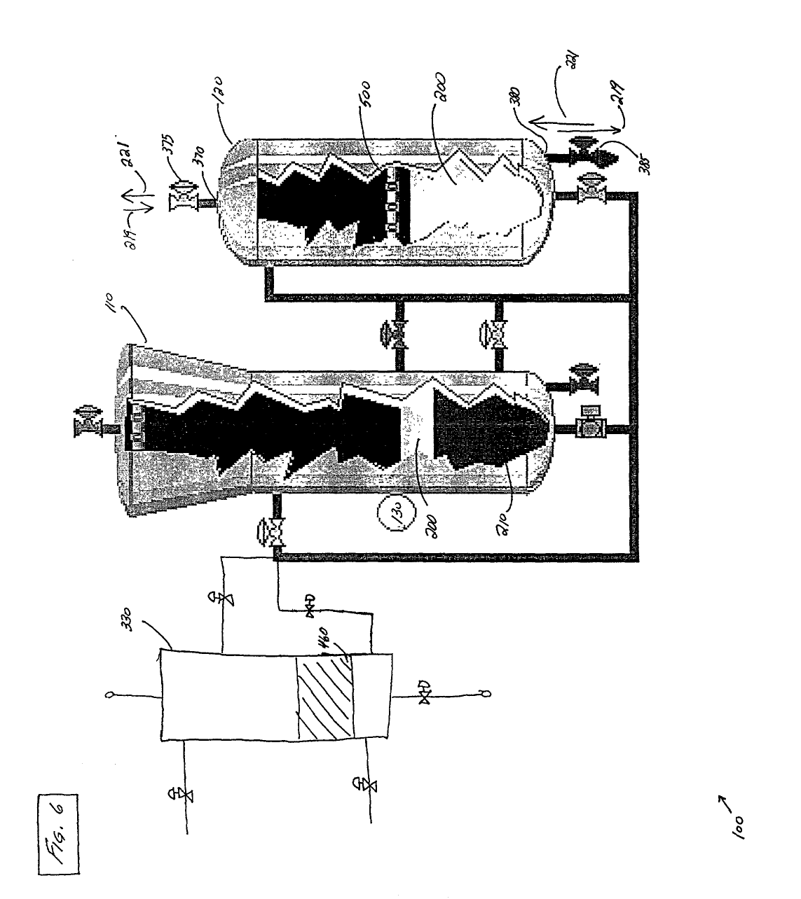

Regeneration of resin 200 in regeneration vessel 120 may occur by any suitable method, depending on the nature of resin 200. In one embodiment of the invention, regeneration of resin 200 may proceed as illustrated by this non-limiting example. A sequence air and water rinses may optionally be applied to the resin by passing air or water through ports 380 and 370, by opening valves 385 and 375. These rinses may remove crud buildup and fines from resin 200. More resin may optionally be added to replace resin lost due to attrition or accidents. Next, suitable regenerant chemicals may be added to the resin, as is known in the art. For example, the resin regenerant entering regeneration vessel 120 through port 380 and flow upwards, exiting through port 370, as indicated by arrows 221 in FIG. 6. Alternatively, the resin regenerant fluid may enter regeneration vessel 120 through port 370 and flow downwards to port 380, as indicated by arrows 219. The cation resin may be regenerated by exposing it to a strong acid, such as sulfuric or hydrochloric acid, while anion resin may be regenerated by exposing it to a strong base, such as ammonium hydroxide, sodium hydroxide, lithium hydroxide, or potassium hydroxide. After completion of the chemical regenerant, a slow rinse of resin 200 with air or water may optionally occur, as previously described. Resin 200 may be regenerated within regeneration vessel 120 until a certain end point has been reached. This end point may be, for example, a certain length of time, such as an hour, or it may be until the concentration of an ion or other molecule has reached a particular level. The ion concentration may be measured by any suitable device, such as an osmometer, a densitometer, an ion chromatography column, or a gas chromatography/mass spectrometry system.

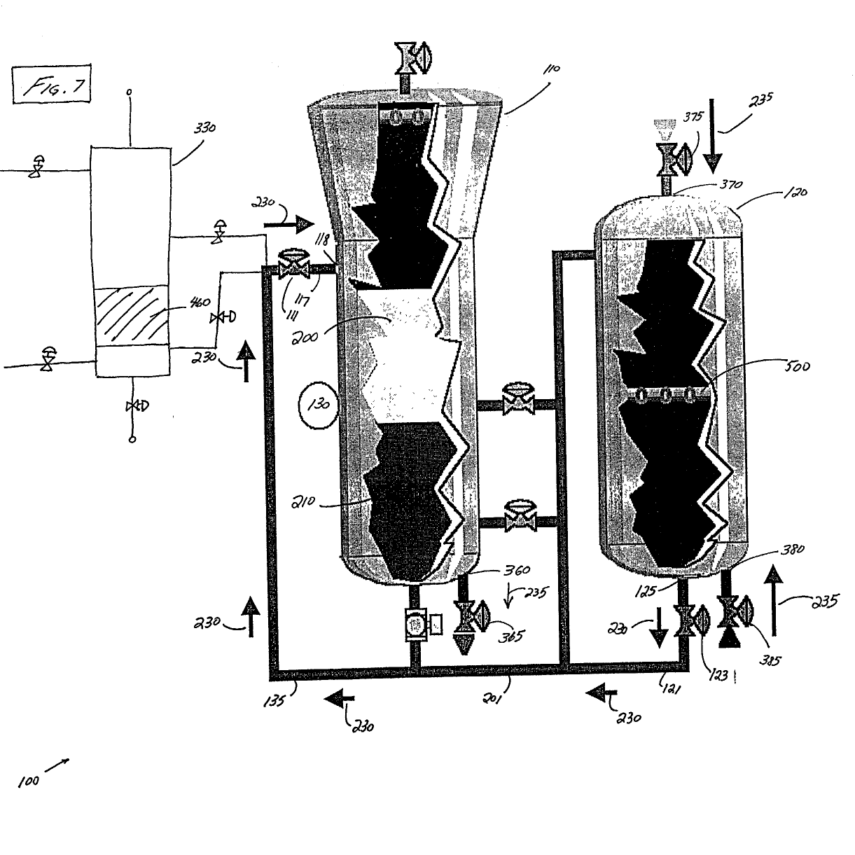

Upper resin 200 may then be transferred back to separation vessel 110 by any suitable means, such as hydro-pneumatically. For example, in one embodiment, as shown in FIG. 7, regenerated upper resin 200 may be transferred from regeneration vessel 120, back to separation vessel 110 through inlet 118, as indicated by arrows 230. Resin 200 leaves regeneration vessel through outlet 125 and open valve 123. Resin 200 then passes through lines 121, 201, 135, and 117 before entering inlet 118 of separation vessel 110 through open valve 111. Resin-fluidizing fluids may also be used to assist in the transfer process. For example, valves 375 and 385 may be opened to allow a fluid such as water to enter regeneration tank 120. Valve 365 on separation tank 110 may also be opened to provide an outlet for the resin-fluidizing fluid. This process is illustrated by arrows 235 in FIG. 7. Optionally, dual end line flushing may be performed to ensure complete transfer of resin 200, as previously described. After the transfer of resin 200 back to separation vessel 110 has been completed, valves 111, 123, 365, 275 and 385 may be closed. At this point, regeneration vessel 120 may nearly be empty of resin 200, and separation vessel 110 may contain the regenerated resin 200, as well as unregenerated resin from the lower resin 210.

Optionally, a second reclassification step may be performed in separation vessel 110, similar to the initial separation of the resin mixture, as previously described. This second reclassification step may ensure that resins 200 and 210 remain separate, as some intermingling may have occurred when re-introducing regenerated resin 200 into separation vessel 110. In certain embodiments of the invention, the portion of lower resin 210 that was transferred along with upper resin 200 into regeneration vessel 120 may facilitate separation of the resins during this step.

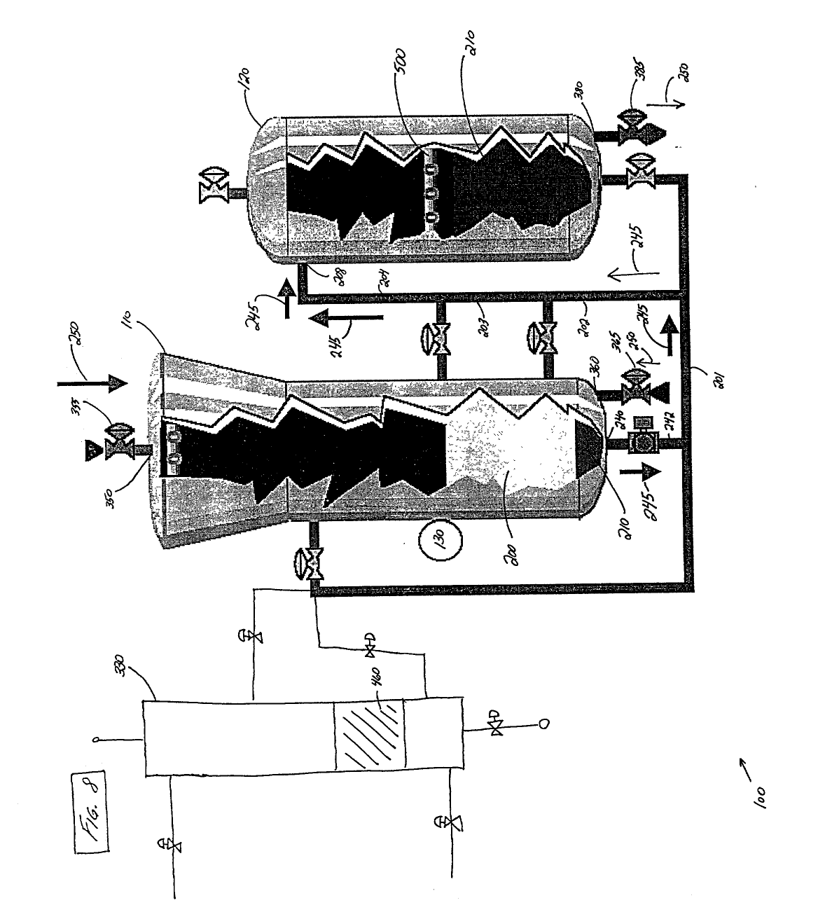

Lower resin 210 is then transferred to regeneration vessel 120 through outlet 240 located at or near the bottom of separation vessel 110, passing through lines 242, 201, 202, 203, and 204, as indicated by arrows 245 on FIG. 8. Lower resin 210 enters regeneration vessel 120 through inlet 208. In FIG. 8, this inlet is the same inlet 208 previously used to introduce upper resin 200. However, this inlet does not necessarily have to be the same inlet previously used by upper resin 200. Optionally, a fluid such as water may be added to facilitate the transfer, which may enter separation vessel 110 through ports 350 or 360. The water may then be drained after the transfer through port 380 of regeneration vessel 120. Flow of the resin-fluidizing fluid may be controlled by valves 355, 365, or 385; this flow is indicated by arrows 250. The force of fluid entering separation vessel 110 from port 360 at a very small flow rate may facilitate leveling and movement of resin 210 towards outlet 240. The transfer of resin may be stopped when the volume of resin within the vessel falls below a certain amount, indicating that an adequate amount of resin 210 has been transferred into regeneration vessel 120. Not all of resin 210 may be transferred; a small “heel” portion of resin 210 may remain within separation vessel 110 after the transfer has been completed.

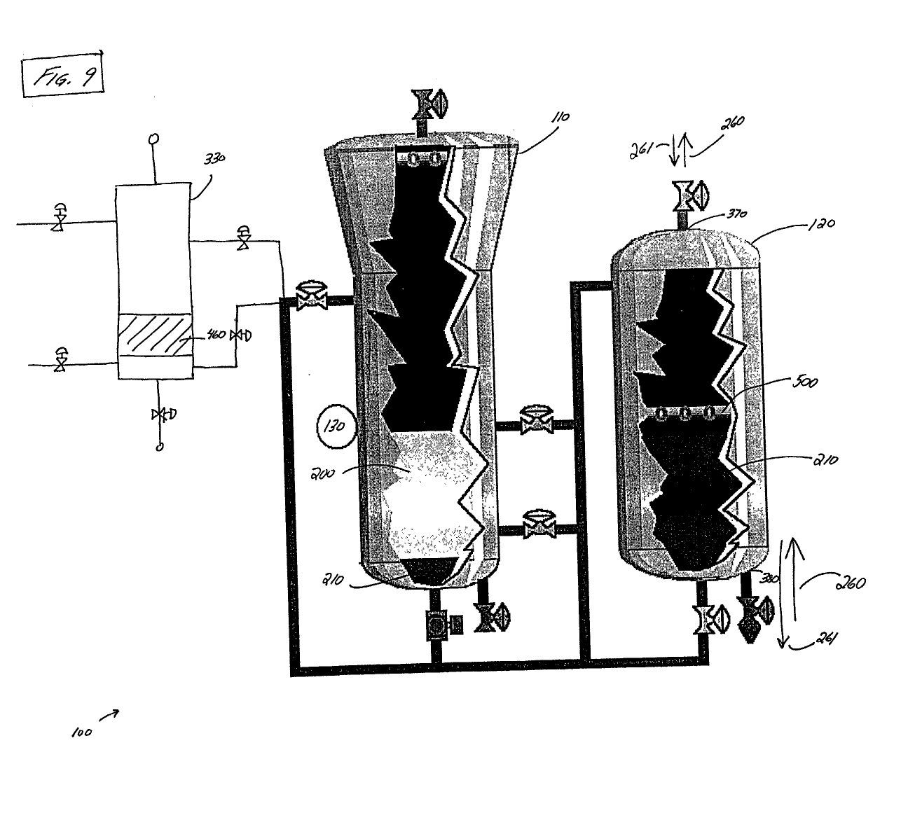

The transfer of resin may be stopped when the total resin level falls below a device or sensor 130 mounted on the side of separation vessel 110 that senses the lack of resin. Alternatively, sensor 130 may measure the upper surface of resin 200. Above resin 200 may be a fluid, for example, air or a carrier fluid such as water; thus, the sensor may detect the resin/water interface. After the transfer of resin 210 to regeneration vessel 120, separation vessel 110 may contain regenerated resin 200 and a residual amount of resin 210. Resin 210 may then be regenerated within regeneration vessel 120 by any suitable method of regeneration or rinsing, as previously described above with resin 200. This is illustrated in FIG. 9, with the flow of regenerant through ports 370 and 380 of regeneration vessel 120, as indicated by arrows 260 with regenerant entering through port 380, or arrows 261 with regenerant entering through port 370.

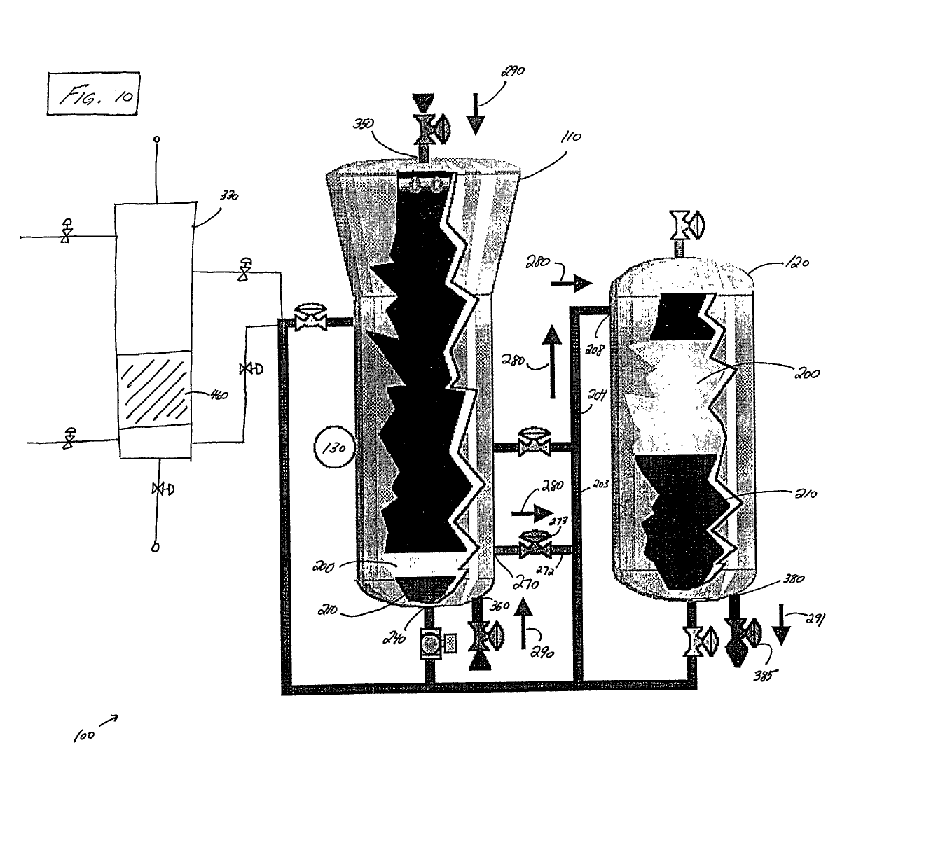

Regenerated resin 200 in separation vessel 110 may then be transferred to regeneration vessel 120. Transferal of resin 200 to regeneration vessel 120 may occur by any suitable means, for example, hydro-pneumatically or hydraulically. Transferal may occur, for example, through outlet 270 and valve 273 of separation vessel 110, passing through lines 272, 203, and 204. In some embodiments of the invention, outlet 270 may be located at or near the bottom of separation vessel 110, as illustrated in FIG. 10. However, in other embodiments, outlet 270 may be positioned elsewhere, such as on the side of separation vessel 110, or transferal of resin 200 may occur through outlet 240, or any other outlet that may be located on separation vessel 110. The transfer of regeneration resin 200 does not need to be a complete transfer. In FIG. 10, a portion of regeneration resin 200 remains in separation vessel 110 after the transfer has been completed. The amount of resin transferred may be an amount with a predetermined mass or volume. Alternatively, the amount of resin transferred may be the amount of resin that can be transferred from separation vessel 110 to regeneration vessel 120 in a predetermined period of time.

The resins in FIG. 10 are depicted as entering regeneration vessel 120 through inlet 208. However, this inlet does not necessarily have to be the same inlets previously used as described for lower resin 210 and upper resin 200. These three inlets may be the same inlet in regeneration vessel 120, or they may be three different inlets. The resin flow is indicated in FIG. 10 by arrows 280. A fluidizing fluid, for example, water, may be introduced into separation vessel 110, either through the top of the vessel, the bottom of the vessel, or another suitably placed inlet. For example, in one embodiment illustrated in FIG. 10, water or another fluid may enter the top of separation vessel 110 through port 350, or through the bottom through port 360, as indicated by arrows 290. The force of fluid entering the vessel may facilitate leveling and movement resin 200 towards outlet 270. By opening valve 385, fluid may leave the system through port 380 of regeneration vessel 120, as indicated by arrow 291.

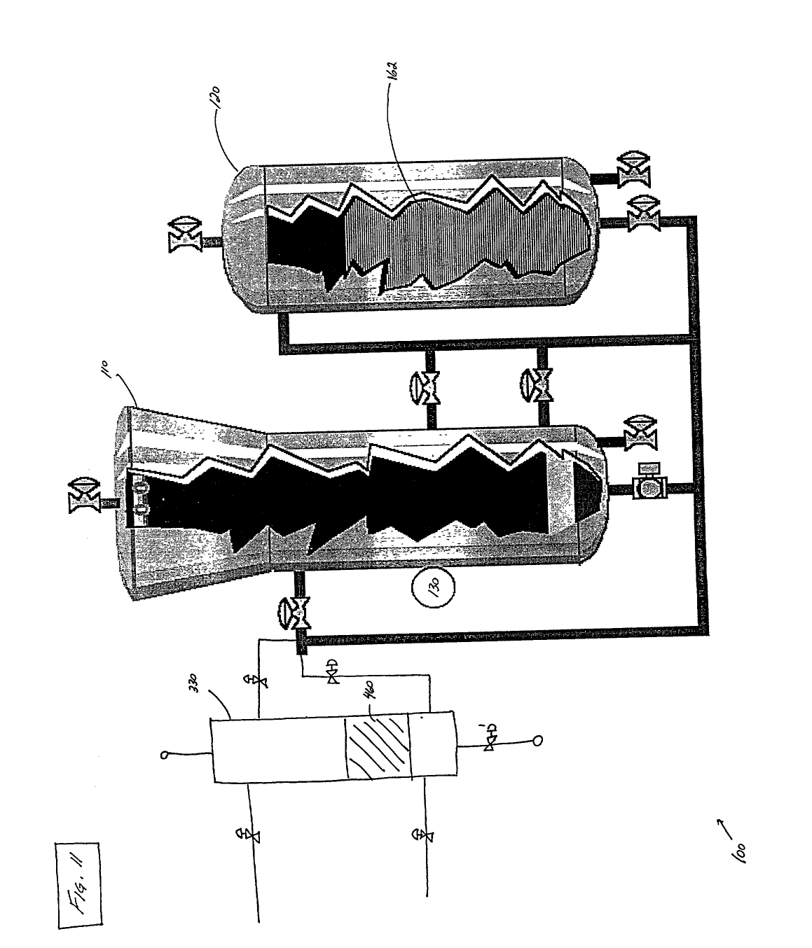

Optionally, resins 200 and 210 in regeneration vessel may be mixed together using any suitable means, for example, by an impeller, or by air or water flow. The resins may also be additionally rinsed with a fluid, such as air or water, as desired. In FIG. 11, resins 200 and 210 are depicted after mixing, forming a regenerated resin 162.

Regenerated resin 160 is then ready to be used again, for example, in service vessel 330. This situation is similar to the situation depicted in FIG. 1, where the resins in regeneration vessel 120 are ready for service. Thus, the regeneration of the resin in this embodiment has been completed. Transfer of the resin 162 to service vessel 330 and transfer of resin 460 to separation vessel 110 for regeneration may proceed as previously described, beginning the next resin regeneration cycle.

Those skilled in the art will readily appreciate that all parameters and configurations described herein are meant to be exemplary, and that the actual parameters and configurations will depend upon the specific application for which the systems and methods of the present invention are utilized. Those skilled in the art will recognize, or be able to ascertain using no more than routine experimentation, many equivalents to the specific embodiments of the invention as described herein. For example, the number of inlets and outlets may be changed as needed, or monitoring, sensing, pumping, or holding equipment may be added to the vessels or to the lines interconnecting the vessels. Other steps may also be added to the method without departing from the scope of the invention, for example, using various “hold” points to determine the status of the operation, additional washing or rinsing steps, or taking measurements of the resins during operation, such as for quality control purposes. A sequence of steps to initially scrub the resins with air, water, or other fluids may also be performed before or after contacting the resins to acids or bases during regeneration, which may remove the buildup of fines and other particulates from the resins.

It is therefore to be understood that the foregoing embodiments are presented by way of example only, and that within the scope of the appended claims and equivalents thereto, the invention may be practiced otherwise than as specifically described. The present invention is directed to each individual feature, system, or method described herein. In addition, any combination of two or more such features, systems or methods, if such features, systems or methods are not mutually inconsistent, is included within the scope of the present invention.

What is claimed is:

1. A system to regenerate ion exchange resin, comprising:
a first vessel comprising an ion exchange resin, at least one inlet, at least one outlet, and an interface sensor positioned to determine the ion exchange resin height; and
a second vessel comprising at least one inlet fluidly connected to at least one outlet of the first vessel, and at least one outlet fluidly connected to at least one of the inlet of the first vessel and a water treatment system.

2. The system to regenerate ion exchange resin of claim 1, wherein the ion exchange resin comprises a cation resin and an anion resin.

3. The system to regenerate ion exchange resin of claim 2, wherein the at least one outlet of the first vessel comprises a cation resin outlet.

4. The system to regenerate ion exchange resin of claim 3, wherein the cation resin outlet is fluidly connected to at least one inlet of the second vessel.

5. The system to regenerate ion exchange resin of claim 2, wherein the at least one outlet of the first vessel comprises an anion resin outlet.

6. The system to regenerate ion exchange resin of claim 5, wherein the anion resin outlet is fluidly connected to at least one inlet of the second vessel.

7. The system to regenerate ion exchange resin of claim 1, wherein the at least one inlet of the first vessel comprises a mixed resin inlet.

8. The system to regenerate ion exchange resin of claim 1, wherein the at least one inlet of the first vessel comprises a resin-fluidizing fluid inlet.

9. The system to regenerate ion exchange resin of claim 1, wherein the interface sensor is connected to at least one of a valve and a pump.

10. The system to regenerate ion exchange resin of claim 1, wherein the interface sensor is connected to a control system that controls a resin flow.

11. The system to regenerate ion exchange resin of claim 1, wherein the interface sensor controls a fluid flow through at least one outlet of the first vessel.

12. The system to regenerate ion exchange resin of claim 1, wherein the interface sensor controls a fluid flow through at least one inlet of the first vessel.

13. The system to regenerate ion exchange resin of claim 1, wherein the interface sensor controls a fluid flow through at least one inlet of the second vessel.

14. The system to regenerate ion exchange resin of claim 1, wherein the second vessel further comprises a first regenerant fluid inlet and a second regenerant fluid inlet.

15. A system to purify a fluid, comprising:
a first vessel comprising an ion exchange resin, at least one inlet, at least one outlet, and an interface sensor positioned to determine the ion exchange resin height;
a second vessel comprising at least one inlet fluidly connected to at least one outlet of the first vessel, and at least one outlet; and
a third vessel comprising at least one inlet fluidly connected to at least one outlet of the second vessel.

16. The system to purify a fluid of claim 15, wherein the ion exchange resin comprises a cation resin and an anion resin.

17. The system to purify a fluid of claim 16, wherein the at least one outlet of the first vessel comprises a cation resin outlet.

18. The system to purify a fluid of claim 16, wherein the at least one outlet of the first vessel comprises an anion resin outlet.

19. The system to purify a fluid of claim 15, wherein the interface sensor is connected to at least one of a valve and a pump.

20. The system to purify a fluid of claim 15, wherein the interface sensor is connected to a control system that controls a resin flow.

21. The system to purify a fluid of claim 15, wherein the interface sensor controls a fluid flow through at least one outlet of the first vessel.

22. The system to purify a fluid of claim 15, wherein the interface sensor controls a fluid flow through at least one inlet of the first vessel.

23. The system to purify a fluid of claim 15, wherein at least one outlet of the second vessel is fluidly connected to at least one inlet of the first vessel.

24. The system to purify a fluid of claim 15, wherein the second vessel further comprises a first regenerant fluid inlet and a second regenerant fluid inlet.

25. The system to purify a fluid of claim 15, wherein the third vessel further comprises at least one outlet fluidly connected to at least one inlet of the first vessel.

26. The system to purify a fluid of claim 15, wherein the third vessel is fluidly connected to a point of entry and a point of use.

27. A method to regenerate a spent ion exchange resin mixture, comprising:
providing a first vessel and a second vessel;
providing a spent ion exchange resin mixture in the first vessel;
separating the spent ion exchange resin mixture in the first vessel into a first spent resin and a second spent resin;
transferring the first spent resin to the second vessel;
regenerating the first spent resin in the second vessel to produce a first regenerated resin;
transferring the first regenerated resin to the first vessel;
transferring the second spent resin to the second vessel; and
regenerating the second spent resin in the second vessel to produce a second regenerated resin.

28. The method to regenerate a spent ion exchange resin mixture of claim 27, wherein the step of separating the spent ion exchange resin mixture comprises separating the spent ion exchange resin mixture into a first spent resin having a degree of separation greater than about 99% and a second spent resin having a degree of separation greater than about 99%.

29. The method to regenerate a spent ion exchange resin mixture of claim 27, further comprising the step of transferring the first regenerated resin to the second vessel after the step of regenerating the second spent resin in the second vessel.

30. The method to regenerate a spent ion exchange resin mixture of claim 29, further comprising the step of mixing the first regenerated resin and the second regenerated resin together to form a regenerated ion exchange resin mixture.

31. The method to regenerate a spent ion exchange resin mixture of claim 27, wherein the step of transferring the second spent resin to the second vessel comprises transferring the se con d spent resin to t he second vessel until a predetermined volume has been measured.

32. A method to regenerate a spent ion exchange resin mixture, comprising:
providing a first vessel, a second vessel, and a third vessel;
providing a spent ion exchange resin mixture in the third vessel;
transferring the spent ion exchange resin mixture from the third vessel to the first vessel;
separating the spent ion exchange resin mixture in the first vessel into a first spent resin and a second spent resin;
transferring the first spent resin to the second vessel;
regenerating the first spent resin in the second vessel to produce a first regenerated resin;
transferring the first regenerated resin to the first vessel;
transferring the second spent resin to the second vessel; and
regenerating the second spent resin in the second vessel to produce a second regenerated resin.

33. The method to regenerate a spent ion exchange resin mixture of claim 31, wherein the step of separating the spent ion exchange resin mixture comprises separating the spent ion exchange resin mixture into a first spent resin having a degree of separation greater than about 99% and a second spent resin having a degree of separation greater than about 99%.

34. The method to regenerate a spent ion exchange resin mixture of claim 32, further comprising the step of transferring the first regenerated resin to the second vessel after the step of regenerating the second spent resin in the second vessel.

35. The method to regenerate a spent ion exchange resin mixture of claim 34, further comprising the step of mixing the first regenerated resin and the second regenerated resin together to form a regenerated ion exchange resin mixture.

36. The method to regenerate a spent ion exchange resin mixture of claim 35, further comprising the step of transferring the regenerated ion exchange resin mixture to the third vessel.

37. The method to regenerate a spent ion exchange resin mixture of claim 32, wherein the step of transferring the second spent resin to the second vessel comprises transferring the second spent resin to the second vessel until a predetermined volume has been measured.

38. The method to regenerate a spent ion exchange resin mixture of claim 32, further comprising the step of providing a second regenerated ion exchange resin mixture in the second vessel.

39. The method to regenerate a spent ion exchange resin mixture of claim 38, further comprising the step of transferring the second regenerated ion exchange resin mixture to the third vessel.

40. The method to regenerate a spent ion exchange resin mixture of claim 39, further comprising the step of passing a fluid across the second regenerated ion exchange resin simultaneously with the step of regenerating the first resin in the second vessel.

41. The method to regenerate a spent ion exchange resin mixture of claim 39, further comprising the step of passing a fluid across the second regenerated ion exchange resin simultaneously with the step of regenerating the second resin in the second vessel.
